(19) United States
(12) Patent Application Publication
(10) Pub. No.: US 2009/0128342 A1
(43) Pub. Date: May 21, 2009

(54) Personal sporting activity monitor

(76) Inventor: David Cohen, Tel-Aviv (IL)

Correspondence Address: MARTIN D. MOYNIHAN d/b/a PRTSI, INC., P.O. BOX 16446, ARLINGTON, VA, 22215, US

(21) Appl. No.: 11/921,561

(22) PCT Filed: Jun. 5, 2006
(86) PCT No.: PCT/IL06/00648

§ 371 Date: Dec. 5, 2007

(30) Foreign Application Priority Data
Jun. 5, 2005 (IL) 169010

(51) Int. Cl. G08B 23/00; G06F 19/00

(52) U.S. Cl. 340/573.1; 702/19

(57) ABSTRACT

A personal sports monitor for monitoring sporting activity, comprises: an input unit for receiving physiological or physical measurements from a subject during a sporting activity, and a logical unit for receiving the measurements and processing them in light of a user profile, to provide feedback regarding the sporting activity.

### FIELD OF THE INVENTION

The present invention relates to a personal sporting activity monitoring device and a method of use thereof.

### BACKGROUND OF THE INVENTION

During sporting activities the body goes through stresses and strains and can be subject to injury. Often the first the sports person knows of the difficulty is when the injury occurs. It is desirable for the sports person to be able to obtain some kind of advance warning regarding impending injuries and overworking. This is especially important for elderly persons or persons unused to exercise.

### SUMMARY OF THE INVENTION

According to a first aspect of the present invention there is provided a personal sports monitor for monitoring sporting activity, comprising:

an input unit for receiving physiological or physical measurements from a subject during said sporting activity,

a logical unit associated with said input unit for receiving said measurements and processing said measurements in light of a user profile, thereby to provide feedback regarding said sporting activity.

Preferably, said logical unit is further configured to infer the presence of a potentially harmful situation.

The monitor may further comprise an alert unit for alerting a user regarding said potentially harmful situation.

Preferably, said alert unit is any one of a group comprising a buzzer, a vibrator, an acoustic unit and a visual alert unit.

Preferably, said alert unit is wirelessly connected to said monitor.

The monitor may be configured to notify a third party upon inference of said potentially harmful situation.

The monitor may comprise thresholding of at least one of said physiological and said physical information.

The monitor may be configured for attachment to said subject.

The monitor may be configured for attachment to the trunk region of a user, above the hip region.

The monitor may be configured for attachment to the chest.

The monitor may be configured for attachment around the stomach.

The monitor may be configured for attachment on the hips.

Preferably, said physiological information comprises pulse rate information.

Preferably, said physiological information comprises breathing rate information.

Preferably, said physiological information is sweat level information.

Preferably, said physiological information is body temperature information.

The monitor may be configured to measure an external temperature-humidity factor.

The monitor preferably comprises a sensor for detecting ECG information.

The monitor is preferably configured to interpret extremely low stress level information as said subject being in a state of sleep.

The monitor may comprise an inclination detector affixed to said subject.

The monitor may comprise an accelerometer.

Preferably, said logic unit is connected to detection logic to identify physical behavior patterns.

Preferably, said patterns comprise complexes of impact and sway behavior events.

Preferably, said input unit is responsive to transmitter units placed on said subjects.

The unit may be configured to detect acceleration and to compare said acceleration with a preprogrammed weight of said subject in order to determine that said subject is being subjected to a dangerous level of force.

Preferably, said logic unit is configured to include a factor for a terrain type.

Preferably, said logic unit is configured to include said factor by at least one of: analysis of g-force, learning based on g-force, and pre-programming.

Preferably, said profile comprises a personal body structure.

The monitor may comprise location detection functionality for determining a location, said monitor further being configured to report said location.

Preferably, said location detection functionality is one of a group comprising a GPS detector and a triangulation system.

The monitor may comprise a direction sensor, said direction sensor comprising a compass and functionality for measuring an angle of said compass in relation to a reference.

The monitor preferably comprises a memory stack for storing a predetermined amount of immediately preceding data, said monitor being configured to save data in said stack.

The monitor may comprise a short range communicator for communicating with a relay device.

Preferably, said relay device is connected to a telephone socket.

Preferably, a first relay is associated with a user and a second relay is associated with a telephone socket.

Preferably, said relay device is a cellular relay device.

The monitor may comprise a first relay associated with a user and a second relay being a cellular relay device.

In one embodiment, said relay device is a satellite telephony device.

Preferably, the monitor comprises a first relay associated with a user and a second relay being a satellite telephony device.

In one embodiment the relay device is an r.f. relay.

In one embodiment a first relay is associated with a user and a second relay is an R.F. relay.

Preferably, said short range communicator is configured to use a wireless local network protocol.

The monitor may be configured to be programmed via an external device.

The monitor may be configured to exchange data via an external device.

According to a second aspect there is provided a personal sports monitor for monitoring sporting activity, comprising:

an input unit for receiving physiological or physical measurements from a subject during said sporting activity,

a logical unit associated with said input unit for receiving said measurements and processing said measurements in light of a user profile, thereby to infer physical damage to said subject during the course of said activity.

According to a third aspect of the present invention there is provided personal sports monitor for monitoring sporting activity, comprising:

an input unit for receiving physiological and physical measurements from a subject during said sporting activity,

a logical unit associated with said input unit for receiving said measurements and processing said measurements in light of a user profile, thereby to provide feedback regarding said sporting activity, the logical unit further comprising a comparator unit, for comparing physiological information and physical reaction data, to detect potentially harmful situations in said subject.

According to a fourth aspect of the present invention there is provided a personal sports monitor comprising an accelerometer and a logic unit associated with said accelerometer to process output data from said accelerometer together with a user profile, to provide sports feedback information concerning a user, said accelerometer and said logic unit being comprised in a housing arranged for attachment to the body of a user.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings,

FIG. 1 is a simplified diagram of sports person with a personal sports monitor according to a first embodiment of the present invention;

FIG. 2 is a simplified block diagram of internal components of the device shown in FIG. 1; and

FIG. 3 is a simplified flow chart showing a method of using the device of FIG. 1.

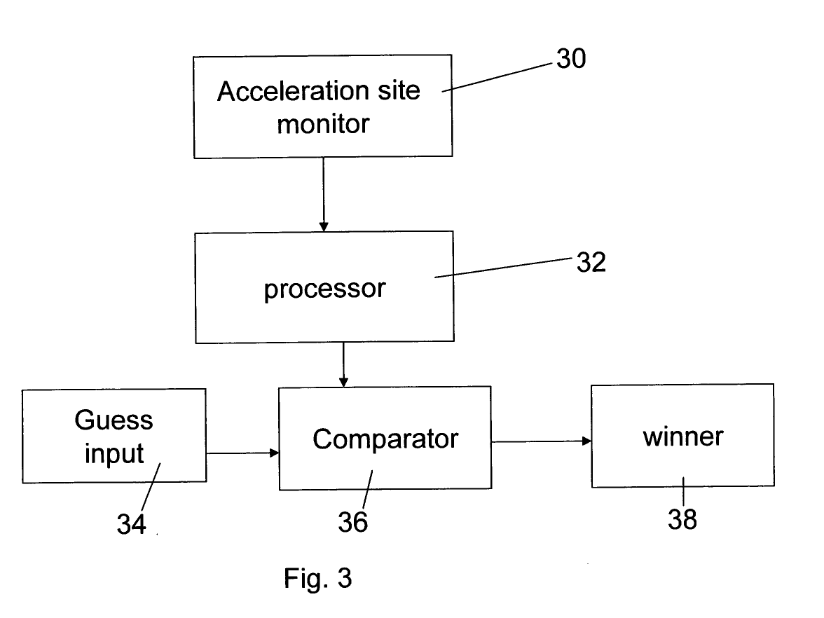

### DESCRIPTION OF THE PREFERRED EMBODIMENTS

The present embodiments provide a personally mounted sports monitor capable of indicating automatically & in real-time any condition of stress or the like which a person engaged in sport is likely to wish to know about in order to prevent excess stress, danger or injury. The sports monitor is able to establish at least some of the following:

that the sports person is placing too much stress on a particular part of the body, especially the back or the knees, that the sports person is moving at a dangerous angle, that the heartbeat or sweat or other physiological reaction indicate a stressful or dangerous situation, and that the sports person is in the wrong location.

In one preferred feature, the sports person's medical condition can be monitored vie ECG, sweat & respiratory state evaluation.

The device can provide a warning to the sports person when a danger condition is indicated. The warning may be auditory, visual or tactile.

Data can be taken from a physical sensor which measures physical body attitude, and forces in general which relate to the external environment, such as an external mechanical impact, a sudden acceleration, a sudden angular change, gases or other substances in the atmosphere and the like. The use of an average, or other combination, of the signals from the various sensors give sophisticated information which can be used in a rule engine to provide outputs based on their combinations. The signals may be measured against a threshold, or a delta may be used.

In a preferred embodiment, the sensor is preprogrammed with the user's weight so that g-forces detected by the accelerometer can be translated directly into the forces being exerted on the user's spine or knees etc.

The sensor may be provided with user profile information such as body type, e.g. slim or broad, and age, sex etc. Thus for example if the system knows that the user is female and has a certain chest size such as DD, then certain inferences may be made about the effect of G forces on the back.

In a further embodiment the monitor device is able to use its measurements to provide data on the effectiveness of particular actions or of training in general.

In one embodiment the device may be placed on the ankle.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

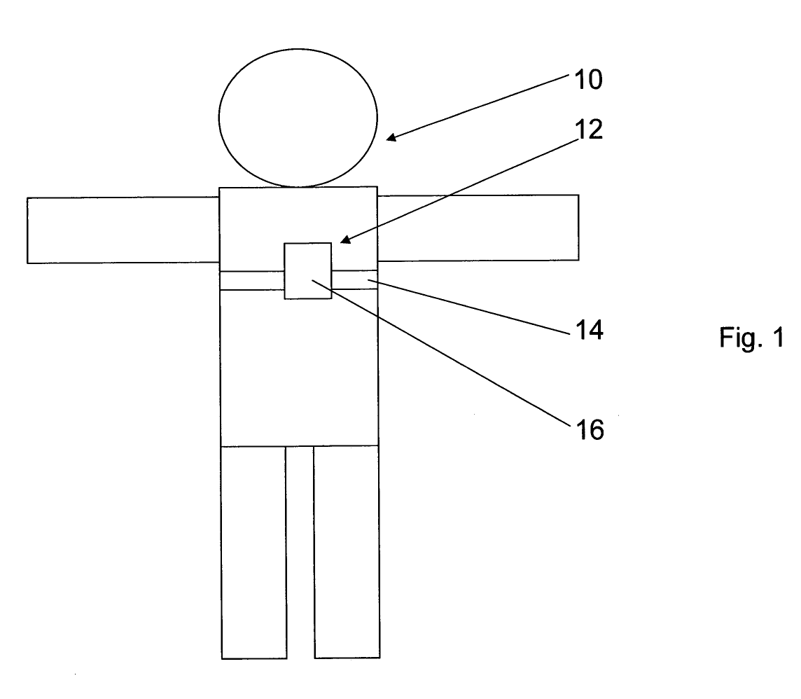

Reference is now made to FIG. 1, which shows an emergency situation detection apparatus placed on a user.

In FIG. 1, a subject 10 has a personal sports monitor 12 attached thereto. The detector comprises a belt 14 and housing module 16. The housing module 16 comprises sensing devices and a transmitter. The detector 12 is preferably able to send signals in non-contact manner to a nearby repeater, which will be discussed in greater detail below. Alternatively some or all of the processing may be carried out locally.

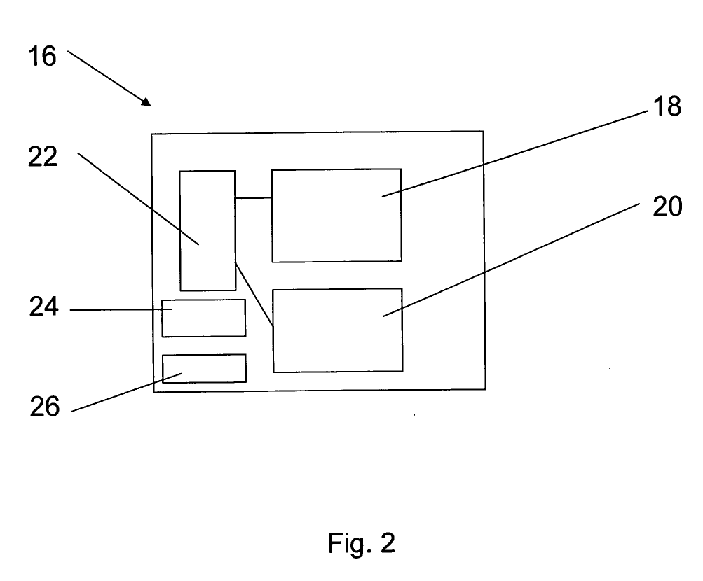

Reference is now made to FIG. 2, which is a simplified block diagram illustrating the interior of housing module 16. The housing module 16 comprises bodily function sensor 18 and physical reaction sensor 20. The bodily function sensor may for example detect pulse rate or sweat levels of the subject. It may also detect ECG or like signals.

The bodily function sensor 18 receives physiological information. The physical reaction detector 20, for example a 3D accelerometer, or a piezoelectric sensor or any other suitable sensor, preferably detects movements, g-forces, angles etc and/or may provide indications of an impact of some kind or the attainment of a horizontal position or like indicators of physical reaction. Additional sensors such as a GPS or other location sensor and the like may be provided as well as spare capacity for adding additional sensors.

Preferably a logic unit 22 is associated with the detectors. In one embodiment there may just be a single detector and the logic unit observes outputs of the unit to make inferences. Thus a monitor may be provided having only a physical detection unit. The physical detection unit may have only an accelerometer, however the logic unit is able to understand much about the sports activity from the output of the accelerometer. Thus the pattern of g-forces could tell the unit that the person is running on hard ground. A given size of g-force may give cause for concern if combined in the logic unit with a user profile indicating an older female, but may be passed as acceptable if in a younger female.

The logic unit may be programmed with personal profiles. The profile may include any information relevant to monitoring of safety or achievement of a given user. The profile may be specific to a given user, or may be generic, say including basic assumptions for age, build and sex. Furthermore the profile may in one embodiment be transmitted or otherwise uploaded to the device from a laptop or the like where it is input using a suitable client program. Hence the monitor device itself does not have to be separately programmable.

In an alternative embodiment the logic unit may carry out only minimal processing of the data. The data is downloaded to a laptop and there processed.

In another embodiment there are both bodily function and reaction detectors, for comparing signal information to apply logical rules and make decisions. The sampling rate may be set to measure the same event at different rates to obtain different information. The detections may be thresholded as deemed sensible by the skilled person to increase reliability of detection. Different thresholds may be appropriate for different kinds of subject. Thus elderly people may be better served by a lower threshold than a candidate for the Olympic team. As a further alternative, instead of a fixed threshold level, the system may monitor the change in signal level over time. The change or delta may then be thresholded. Thresholding the deltas can distinguish high signal levels which are due to a rapidly occurring event from high signal levels which may be due to background stress and the like.

The thresholded output of the comparison unit or output of the logical rules following a positive result of the thresholding, is passed to a state manager 24 to imply the presence of an alarm situation and to enter an alarm state, or to reach any other desired output. The device may be stand-alone. In a non-stand-alone embodiment a transmitter 26 preferably responds to the alarm state manager 26 to transmit alarm signals say via Bluetooth, to the nearby repeater. As well as R.F. the transmitter 26 may be able to transmit using sonic ultrasonic, infra-red or like signals.

When an individual comes under physical stress, such as when he engages in sport, his body is subjected to changes in two identifiable parameter groups, physiological changes and physical changes. The physiological changes include changes in pulse rate, increased sweating and/or changes in the rate of respiration. Physical changes may include changes in the three dimensional angle of recline, a detectable directional impact, a directional sway, changes in motion, thus step count, etc, directional positioning sensing, unexpected changes in the GPS or other positioning fix, audio signals, changes in acceleration or g-force and the like. Thus many persons may sway whilst walking, but the sway is measurably different from the sway of someone walking away with a serious injury, and is different again from someone undergoing an impact. A given g-force may be fine for a certain weight, but persons of greater weight may be endangering their knees and should be warned.

A preferred embodiment of the present invention uses at least a two-layer logic system for describing events and deciding whether to derive an alarm state. In the first level different kinds of events that could indicate trouble are identified. On the second level various combinations of the events in the first level are defined as setting alarm states. The use of the two level system thus reduces the level of computation required in order to arrive at the alarm states.

Examples of the events are as follows: A sudden linear acceleration in any direction, sudden acceleration being defined in any suitable manner, say an acceleration in any direction of greater than 1 G. As well as acceleration in general, there is also angular acceleration. An event of no movement for a period of ten minutes could also be chosen for an alarm, with the time and acceleration being varied depending on whether the sports person is supposed to be moving.

A user falling or leaning forward at a given angle or greater may be one kind of event and the same backwards may be another. Likewise sideways, either left or right can be defined as separate events, and typically different threshold levels would apply to these events.

In a preferred embodiment a relay device may be provided, so that the sports person is in contact with a central control or the like. The relay device may have additional functions. For example it may have its own sensors that are activated upon detection of an emergency situation at a nearby device. Thus it may be connected to a video camera or a microphone.

Once a real state of emergency is determined by the mounted alert device, the following occurs, preferably entirely automatically.

The sports monitor sends an Alert Signal, typically, but not necessarily, via RF.

The sports monitor sends a GPS fix or other geographical fix via RF to the center, affixing the sports person's location on say a target area digital map.

The sports monitor may for example send the sports person's online ECG & respiratory data, enabling real time remote evaluation of a developing medical condition.

As well as dealing with emergency situations, the device is also able to deal with regular situations, reporting on day to day activities. Thus the personally mounted sports monitor preferably constantly records all Data as a memory package. Then, upon request from the center, all audio & data content of the memory package can be downloaded for analysis according to predetermined parameters. It is thus possible to find out such things as whether the sports person is following a training program reliably, whether he is making the correct moves, whether a person is in good health, and the like.

As mentioned above, a preferred embodiment includes a GPS detector to provide positioning information. For use in a building or other places where GPS signals may not be available, a triangulation system may be installed for accurate positional information. As a further alternative, location information may not be provided by the detector 12 but rather by the relay device.

Further preferred embodiments are provided to determine attitude, position and motion of a subject. Thus the personal monitor may include an accelerometer. A detector for detection of a direction that a user is facing may be strapped to the chest or a like part of the body. The detector preferably includes a compass needle and the relative alignment of the compass needle relative to a predefined forward direction of the body provides information as to the direction the user is facing. At the controller's end the individual user may be represented by a 3D animation which reproduces the direction and attitude of the subject.

In one embodiment, data is stored for a predetermined time in a stack, for example a FIFO stack. The size of the stack may be a given amount of data, or may be a given amount of time, or some other factor as preferred. In the event of the detection of a particularly serious emergency situation, all of the data currently in the stack may be saved or immediately transmitted for remote saving, so as to allow subsequent analysis. The stack embodiment is useful because it makes available information from directly before the emergency, often extremely useful in any investigation.

Embodiments of the present invention may use a private communication channel. In one embodiment the equipment located on the user has a short range radio transmitter receiver and a corresponding transmitter receiver is located over a telephone socket, to provide the relay device referred to above. The device at the telephone socket includes an automatic dialer which makes a connection with the controller. For greater range the device at the user may transmit to a repeater which then transmits over a greater range. One embodiment of the repeater may be located at a convenient nearby power socket. Another embodiment may be located on the person. Other embodiments may make use of existing channels such as the cellular network. Yet other embodiments may comprise universal communicators which make use of public networks if detected and use their own channel of communication otherwise.

According to a further embodiment a system comprises rule based logic and one or more body sensors for location on the subject. The subject is expected to follow certain behavioral rules, depending on the sport involved. A marathon runner is expected to run whereas a marksman in a rifle shooting event is expected to lie down. If the marksman were to run or the runner to lie down it would be apparent that an abnormal situation may have arisen. Thus the sensor is usable in combination with the rule based logic to detect non-compliance with the behavioral rules, to indicate an abnormal situation and if necessary to set off an alarm or otherwise summon help. It will be clear that the more independent sensors are used the more reliable the determination can be.

In a preferred embodiment, the detectors are programmable. The rules can be changed for different users or for allowing the same device to be given to different users having different requirements. The device can also be dynamically programmable according to parameters it is able to detect or it is told. Thus it may be able to use detected locations or indicated sports to change between different sets of rules. Or as another example, a device programmed for use by a long-distance runner may change the rules it is using depending say on the temperature it detects. Thus if it is hot it may tell the runner to drink more often. In a further example the change of rules may be carried out on line, for example over a radio connection.

A position or location detector may be used in combination with the above system and the rules preferably define location based behaviors.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1-47. (canceled)

48. Personal sports monitor for monitoring sporting activity, comprising:
an input unit for receiving physiological or physical measurements from a subject during said sporting activity,
a logical unit associated with said input unit for receiving said measurements and processing said measurements in light of a user profile, thereby to provide feedback regarding said sporting activity.

49. The personal sports monitor of claim 48, wherein said logical unit is further configured to infer the presence of a potentially harmful situation.

50. The personal sports monitor of claim 49, further comprising an alert unit for alerting a user regarding said potentially harmful situation.

51. The personal sports monitor of claim 50, wherein said alert unit is any one of a group comprising a buzzer, a vibrator, an acoustic unit and a visual alert unit.

52. The personal sports monitor of claim 50, wherein said alert unit is wirelessly connected to said monitor.

53. The personal sports monitor of claim 49, further configured to notify a third party upon inference of said potentially harmful situation.

54. The personal sports monitor of claim 48, further comprising thresholding of at least one of said physiological and said physical information.

55. The personal sports monitor of claim 48, configured for attachment to the trunk region of a user, above the hip region, or to the chest or around the stomach, or on the hips.

56. The personal sports monitor of claim 48, wherein said physiological information comprises pulse rate information, or breathing information or sweat level information, or body temperature information.

57. The personal sports monitor of claim 48, further configured to measure an external temperature-humidity factor.

58. The personal sports monitor of claim 48, further comprising a sensor for detecting ECG information.

59. The personal sports monitor of claim 48, configured to interpret extremely low stress level information as said subject being in a state of sleep.

60. The personal sports monitor of claim 48, further comprising an inclination detector affixed to said subject.

61. The personal sports monitor of claim 48, further comprising an accelerometer.

62. The personal sports monitor of claim 61, wherein said logic unit is connected to detection logic to identify physical behavior patterns.

63. The personal sports monitor of claim 62, wherein said patterns comprise complexes of impact and sway behavior events.

64. The personal sports monitor of claim 48, further configured to detect acceleration and to compare said acceleration with a preprogrammed weight of said subject in order to determine that said subject is being subjected to a dangerous level of force.

65. The personal sports monitor of claim 48, wherein said logic unit is configured to include a factor for a terrain type.

66. The personal sports monitor of claim 65, wherein said logic unit is configured to include said factor by at least one of: analysis of g-force, learning based on g-force, and pre-programming.

67. The personal sports monitor of claim 48, wherein said profile comprises a personal body structure.

68. The personal sports monitor of claim 48, further comprising location detection functionality for determining a location, said monitor further being configured to report said location.

69. The personal sports monitor of claim 48, associated with a memory stack for storing a predetermined amount of immediately preceding data, said monitor being configured to save data in said stack.

70. The personal sports monitor of claim 48, wherein said logic unit is configured for receiving said measurements and processing said measurements in light of a user profile, thereby to infer physical damage to said subject during the course of said activity.

71. Personal sports monitor for monitoring sporting activity, comprising:
an input unit for receiving physiological and physical measurements from a subject during said sporting activity,
a logical unit associated with said input unit for receiving said measurements and processing said measurements in light of a user profile, thereby to provide feedback regarding said sporting activity, the logical unit further comprising a comparator unit, for comparing physiological information and physical reaction data, to detect potentially harmful situations in said subject.

72. Personal sports monitor comprising an accelerometer and a logic unit associated with said accelerometer to process output data from said accelerometer together with a user profile, to provide sports feedback information concerning a user, said accelerometer and said logic unit being comprised in a housing arranged for attachment to the body of a user.
